(19) United States
(12) Patent Application Publication
(10) Pub. No.: US 2011/0212836 A1
(43) Pub. Date: Sep. 1, 2011

(54) Environment favorable for plant(vegetation) growth, insect control and effective use of fertilizers

(76) Inventor: Kung H. Lee, Chadds Ford, PA (US)

(21) Appl. No.: 12/930,281

(22) Filed: Jan. 3, 2011

Related U.S. Application Data
(60) Provisional application No. 61/339,158, filed on Mar. 1, 2010.

(51) Int. Cl. A01N 59/04; A01P 7/04; A01P 21/00

(52) U.S. Cl. 504/116.1; 424/700

(57) ABSTRACT

This invention relates to a plant (vegetation) protecting and regulating environment which uses excessive amounts of carbon dioxide (CO2) coupled with reduced amounts of oxygen (O2) to, simultaneously and collectively, (1) promote plant (vegetation) growth, (2) provide insect control and (3) render effective use of fertilizers. As an illustrative example, such said environment can be provided by using the waste flue gases from coal-fired power plants.

### CROSS-REFERENCE TO RELATED APPLICATIONS

This invention claims priority under 35 USC /119(e) to U.S. Provisional Pat. App. 61/339,158 filed Mar. 1, 2010

STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

Current U.S. Class: 504/119; 71/25; 47/58.1R

Current International Class: A01N25/04; A01G7/02, 06; A01N31/02 C05F007; C05F011

Field of Search: 504/119; 504/116.1; 504/118; 71/25; 71/11,23,25,26,27,38,64.1; 47/58.1R; 47/15; 435/420; 700/36

Reference Cited

U.S. PATENT DOCUMENTS

| | | |
|---|---|---|
| 7.502,655 | March 2009 | Albright, et al. |
| 6,309,440 | October 2001 | Yamashita |
| 6,237,284 | May 2001 | Erickson |
| 6,110,867 | August 2000 | Glenn, et al. |
| 6,110,866 | August 2000 | Walker |
| 6,069,112 | May 2000 | Glenn, et al. |
| 6,060,314 | may 2000 | Tisserat, et al. |
| 5,797,976 | August 1998 | Yamashita |
| 5,597,400 | January 1997 | Nonomura, et al. |

### OTHER REFERENCES

1. “Towards integrated commodity and pest management in grain storage”: A Training Manual for application in humid tropical storage systems, edited by R. L. Semple, P. A. Hicks, J. V. Lozare, and A. Castermans from “Proceedings and selected papers from the Regional Training Course on Integrated Pest Management Strategies in Grain Storage Systems, conducted by the National Post Harvest Institute for Research and Extension (NAPHIRE), Department of Agriculture, Jun. 6-18, 1988, Philippines.

2. “Modeling Urea Processes from the Virtual Material Group“:—A new thermodynamic model and software integration paradigm, presented at The Chemical Engineers' Resource Page by: Marco A. Satyro, Yau-Kun Li, Rajeev K. Agarwal, and Oscar J. Santollani.

### BRIEF SUMMARY OF THE INVENTION

This invention relates to a plant (vegetation) protecting and regulating environment which uses excessive amounts of carbon dioxide (CO2) coupled with reduced amounts of oxygen (O2) to, simultaneously and collectively, (1) promote plant (vegetation) growth, (2) provide insect control and (3) render effective use of fertilizers. As an illustrative example, such said environment can be provided by using the waste flue gas from coal-fired power plants, which typically contains 10% to 14% carbon dioxide (CO2) and 4% to 6% oxygen (O2) (vs. the normal atmosphere which contains about 0.03% carbon dioxide (CO2) and 20.99% oxygen (O2).

Cited U. S. Patents and References failed to teach an environment which can deal with all the elements in the situation, i.e. (1) plant (vegetation) growth, (2) insect control and (3) fertilizer effectiveness, simultaneously and collectively .

### DETAILED DESCRIPTION OF THE INVENTION

This invention relates to the use of an environment with excessive amounts of carbon dioxide (CO2) coupled with reduced amounts of oxygen (O2) to, simultaneously and collectively, promote plant (vegetation) growth, provide insect control and render effective use of fertilizers.

Plants (including algae, weeds and other vegetation) grow by photosynthesis in an earth atmosphere containing about 0.03% carbon dioxide (CO2) and 20.99% oxygen (O2). The net result of plant photosynthesis produces oxygen with corresponding depletion of carbon dioxide, as shown by the following equation:

n CO2+n H2O2O+Light Energy (CH2O)n+n O2

Thus, any carbon dioxide (CO2) concentration higher than 0.03% will promote the photosynthesis process and any oxygen (O2) concentration lower than 20.99% will also make it easier for the photosynthesis to proceed. In addition, a higher concentration ratio of carbon dioxide (CO2) relative to oxygen (O2) will minimize photorespiration (an undesirable side reaction to photosynthesis) which is detrimental to plant growth. Furthermore, the reduced oxygen (O2) concentration, coupled with the toxicity effect of high carbon dioxide (CO2) content in the environment, will make harmful insects difficult to survive, thus making it possible to reduce the amount or perhaps eliminating the use, of pesticides otherwise needed to protect the plants.

This invention utilizes and consumes carbon dioxide (CO2), therefore will help to reduce carbon dioxide (CO2) emission and thus alleviate global warming.

Excessive water moisture is detrimental to the effective use of fertilizer, especially urea (NH2CONH2) because urea (NH2CONH2) hydrolyses readily according to the following equation:

NH2CONH2+H2O2O2NH3+CO2

The resulting NH3 escapes before it can be fully utilized by the plant. Under an environment of excess CO2, as preached in the invention, the hydrolysis process will be slowed, less amount of NH3 will be lost and the fertilizer can be more efficiently utilized.

In Reference 2, the investigators focused their attention on the manufacture of urea from NH3 and CO2 and studied thoroughly the reaction mechanism and kinetics. But the investigators failed to realize and appreciate the beneficial effect of an excess CO2 environment when the fertilizer is being applied to the crop in the field.

In reference 1, the investigators studied pest management in grain storages and concluded that carbon dioxide (CO2) alone was insufficient to control larvae and eggs to a desirable level without the addition of chemical insecticides. Thus, the idea of using carbon dioxide (CO2) alone was dropped because the control of larvae and eggs in grain storages is a very important consideration . In the case of growing crops, control of insects (not larvae nor eggs) is the primary consideration. Furthermore, the investigators focused their attention entirely on grain storage and failed to realize potential applications elsewhere.

Of particular interest to this invention is the waste flue gases from coal-fired power plants. The waste flue gases from coal-fired power plants typically contain about 10% to 14% carbon dioxide (CO2) and 4% to 6% oxygen (O2) while the normal atmosphere contains about 0.03% carbon dioxide (CO2) and 20.99% oxygen (O2). Thus, these waste flue gases may be beneficially used to provide the favorable environment as preached in this invention

This invention can be applied in many ways depending on the circumstances:
1. For enclosed hot houses, the carbon dioxide (CO2) may be introduced by metering the desired amounts and maintaining at a safe level by constantly monitoring the composition of the environment.
2. For an open field (such as a large corn field), the carbon dioxide (CO2) may be introduced at the center of the field, as close to the ground as practical, allowing the carbon dioxide (CO2) to flow horizontally across the field towards the perimeter of the field, in a laminar flow manner so as to minimize flow disturbances. Carbon dioxide (CO2) , being heavier than the air, will displace air upwards to the tip of the corn stalks, until the corn field is filled with carbon dioxide (CO2) from ground up. Monitoring of the carbon dioxide (CO2) concentration may be done around the field parimeters.

None of the cited patents and references teach an environment which can deal with all the elements in this situation simultaneously and collectively, namely: (1) plant growth, (2) insect control and (3) fertilizer effectiveness.

I claim:

1. Use of an environment with excessive amounts of carbon dioxide (CO2) coupled with reduced amounts of oxygen (O2) to simultaneously facilitate the following functions: (a) promote plant growth (including algae, weeds and other vegetation), (b)control harmful insects to protect the plant growth, and (c) render effective use of fertilizer when fertilizer is applied.
1a. The said excessive amounts of carbon dioxide (CO2) being higher than 0.04% by volume.
1b. The said reduced amounts of oxygen (O2) being less than 20.5% by volume.

2. A waste stream to be used in this application. This waste stream is flue gases from coal-fired power plants, typically containing about 10% to 14% carbon dioxide (CO2) and 4% to 6% oxygen (O2).

3. The afore described application method in relation to the open field, specifically the method is as follows: the carbon dioxide (CO2) is introduced at the center of the field, as close to the ground as practical, allowing carbon dioxide (CO2) to flow horizontally across the field towards the perimeters of the field, in a laminar flow manner so as to minimize flow disturbances. Monitor carbon dioxide (CO2) concentration around the field parameters. Carbon dioxide (CO2), being heavier than air, will displace air upwards to the tips of the corn stalks, until the corn field is filled with carbon dioxide (CO2) from ground up.
